(19) United States
(12) Patent Application Publication
(10) Pub. No.: US 2003/0023889 A1
(43) Pub. Date: Jan. 30, 2003

(54) Apparatus and method for controlling power dissipation and convective cooling to reduce temperature excursion rates in a processing system

(76) Inventors: Harm Peter Hofstee, Austin, TX (US); Gordon J. Robbins, Austin, TX (US)

Correspondence Address: Russell D. Culbertson, Shaffer & Culbertson, L.L.P., Ste. 360, 1250 Capital of Texas Hwy South, Bldg. One, Austin, TX, 78746, US

(21) Appl. No.: 09/915,661

(22) Filed: Jul. 26, 2001

(51) Int. Cl. G06F 1/26; G06F 1/28; G06F 1/30

(52) U.S. Cl. 713/322; 307/152; 307/117; 307/97

(57) ABSTRACT

A transitioning of power dissipation in a processing device (11) is coordinated with the operation of a cooling system (16, 17, 18) for the processing device. A power transitioning arrangement (15) transitions power dissipation in the processing device (11) between a high power level and a relatively lower low power level. In conjunction with a transitioning of the processing device power level, the cooling system (16, 17, 18) is placed in either a high or low thermal impedance state to reduce the rate at which the temperature of the data processing device (11) and related elements change in response to the change in power dissipated by the processing device. Transitioning the power dissipation in the processing device (11) may be accomplished by gradually varying the clock rate for the device, by changing the clock rate to various processing elements in the device at different times, and/or by changing the instruction issue rate in the device.

### TECHNICAL FIELD OF THE INVENTION

The invention relates to data processing systems. More particularly, the invention relates to an apparatus and method for reducing the rate at which the temperature of a processing device changes as the device undergoes a change in operational state. The invention has particular application in data processing systems utilizing power management features which automatically power down processing devices during periods of inactivity.

### BACKGROUND OF THE INVENTION

Government regulations, such as the U.S. “Energy Star” regulations for example, require that processing devices within a processing system be placed in a reduced power state during periods of inactivity. The normal operating power mode may be referred to as an “awake” mode while the low power mode may be referred to as a “sleep” or “standby” mode. The change in operating states or modes may be controlled by power management program instructions executed by a processing device included in the processing system. The power management program detects inactivity in the processing system and causes various elements of the system, including processing devices, to be powered down to the low power or sleep mode after a certain period of inactivity. Conversely, when the power management program detects certain types of system activity, it causes the various elements of the system to switch back to the normal operating or “awake” mode.

Reducing the power consumption in a digital processing device may be accomplished by reducing the clock rate from the normal operating clock speed of the processing device to some lower clock rate. Reducing the clock rate causes the processing device to dissipate less power and thus generate less heat as compared to the relatively higher, normal operating clock rate. Power consumption in a digital processing device may also be reduced by reducing the rate at which instructions are issued in the device.

The low power dissipation, low-temperature operation of a processing device in its sleep mode generally increases the life of semiconductor devices included in the processing device by slowing semiconductor failure mechanisms such as electromigration and dopant diffusion, for example. However, the temperature changes or excursions resulting from changes in power dissipation levels in a processing device, produce mechanical stress in package level components of the processing system. This mechanical stress results from the different thermal coefficient of expansion values of the various elements in the integrated circuit system, and from the different heat capacities and thermal impedances between various elements in the processing system. The expansion and contraction of different elements in the processing system causes mechanical fatigue particularly in the physical interconnections between elements. Typical fatigue induced failures occur in physical interconnections such as ball grid arrays, column grid arrays, chip to header attachments, chip to package or C4 attachments, as well as other mechanical interconnections associated with the processing device.

U.S. Pat. No. 5,737,171 to Buller et al. addresses the problem of stresses in electronic data processing systems occasioned by power management cycling. The Buller patent discloses a system having a cooling fan capable of forcing air over a heat sink to help remove heat from a system processing device in normal system operation. According to the Buller patent, the fan operation is coordinated with the power state of the processing device in order to both reduce the rate of temperature change in the processing device and reduce the overall temperature change experienced by the processing device. More specifically, the fan disclosed in the Buller patent is controlled by the power state signal provided by the power management system. The fan is simultaneously turned off when the processing device state is switched from the high to low power mode and simultaneously turned on when the processing device is switched from the low to high power mode. This switching of the fan operation has the effect of modifying the thermal impedance associated with the heat sink for the processing device. Turning the fan off when the processing device is switched from the high power mode to the low power mode effectively increases the thermal impedance associated with the heat sink. This higher thermal impedance slows the rate of cooling occasioned by the power level change in the processing device. Conversely, turning the fan on when the processing device is switched from the low power mode to high power mode greatly decreases the thermal impedance associated with the heat sink and slows the rate at which the temperature of the processing device increases as a result of the power level increase.

The Buller patent represented an improvement in reducing thermal stress and fatigue due to power management cycling. However, it is desirable to further reduce the rate of temperature changes occurring in a processing system due to power management cycling. The present invention represents an improvement in reducing thermally induced stress and fatigue problems in processing systems by even further reducing the rate at which temperatures change in a processing element or device in response to power management cycling.

### SUMMARY OF THE INVENTION

It is an object to the invention to provide an apparatus and method for reducing the rate of temperature change in a data processing device as the device experiences a temperature excursion occasioned by a change in operational state. More particularly, it is an object of the invention to provide both an apparatus that can be used with a processing device to reduce the rate of temperature change in the device, and an integrated processing system which incorporates the apparatus for reducing the rate of temperature change. It is also an object of invention to provide a method for reducing the rate at which temperature changes in a processing device as the device undergoes a change in operational state.

These objects are accomplished by coordinating a transitioning of power dissipation in a processing device with a cooling system associated with the processing device. The invention includes a power transitioning arrangement for transitioning power dissipation between a high power level and a relatively lower, low power level. By “transitioning” it is meant that the power dissipation change in the device is gradual with a resultant gradual change in the heat generated by the processing device. In conjunction with transitioning the power level of the data processing device, the invention places the cooling system in either a high or low thermal impedance state to reduce the rate at which the temperature of the data processing device and related elements changes in response to the change in power dissipated by the processing device.

The power transitioning arrangement according to the invention may be implemented in several different ways. One preferred arrangement uses a power state signal which may be the normal power management wake/sleep signal and/or a system on/off signal to start a clock frequency modifying sequence using a frequency divider. In response to a sleep signal or an off signal, the frequency divider gradually reduces the clock rate to provide a gradual reduction in power dissipation in the processing device. Conversely, in response to a wake signal or an on signal, the frequency divider gradually increases the clock rate up to the normal operating clock rate for the processing device.

Alternatively or in addition to gradually changing the processing device clock rate, different processing elements in a multi-element processing device may be powered down or up at different times in a step wise fashion. This step wise modification of power dissipation in the various processing elements of a multi-element device has the effect of spreading the overall power dissipation change over a longer period of time, thereby slowing the rate of temperature change occasioned by the power level change. Furthermore, the instruction issue rate in a processing device may be changed gradually within the scope of the invention, either alone or in concert with a clock rate change, to reduce the rate of temperature change in the processor.

The invention utilizes a cooling system that alternatively provides a low thermal impedance for the processing device and a relatively higher, high thermal impedance for the processing device. A cooling system controller places the cooling system at the high thermal impedance in conjunction with a transitioning from high power dissipation level to low power dissipation level. The cooling system controller also places the cooling system at the low thermal impedance in conjunction with a transitioning from the low power dissipation level to the high power dissipation level. The preferred cooling system includes a fan for forcing air over the surfaces of a heat sink associated with the processing device. The cooling system controller includes a switching device that operates under the control of the power management wake/sleep signal and perhaps a power on/off signal to switch the cooling system between the two thermal impedance conditions.

In one aspect of the invention, the power transitioning arrangement produces a delay in power transitioning with respect to the cooling system control in order to account for the time required for the fan speed to change as the fan is turned on or off by the cooling system controller. This delay causes the fan to be turned off slightly before beginning the transitioning from high power level to low power level in the processing device. Conversely, the fan is turned on slightly before a transitioning from the low power dissipation level to high power dissipation level in the processing device.

These and other objects, advantages, and features of the invention will be apparent from the following description of the preferred embodiments, considered along with the accompanying drawings.

### BRIEF DESCRIPTION OF THE DRAWINGS

FIG. 1 is a diagrammatic representation of a data processing system embodying the principles of the invention.

FIG. 2 is a diagrammatic representation of the power transitioning arrangement shown in FIG. 1.

FIG. 3 is a timing diagram relating plots of power/clock speed and temperature to illustrate the effects of the present invention.

FIG. 4 is a flow chart showing a process according to the present invention.

### DESCRIPTION OF THE PREFERRED EMBODIMENTS

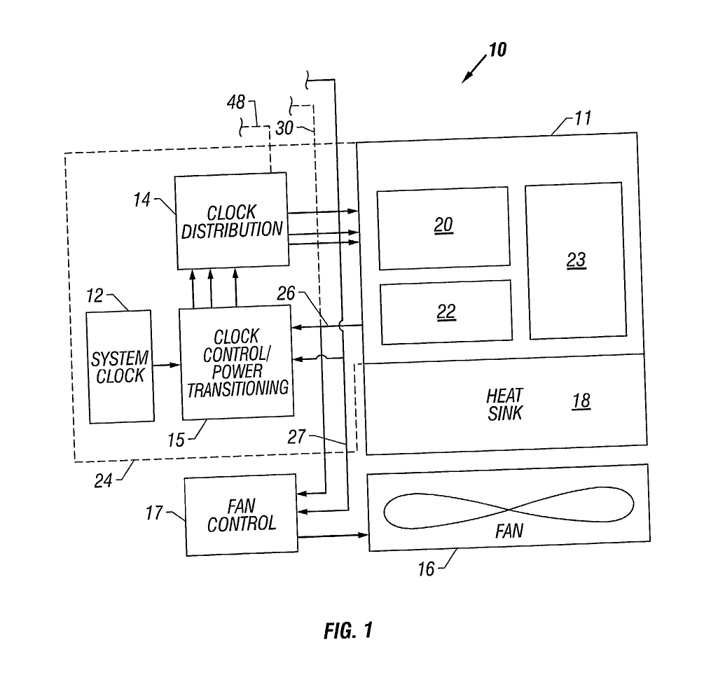

FIG. 1 shows a data processing system 10 embodying the principles of the invention. Data processing system 10 includes a processor or processing device 11, a system clock generator 12, and a clock distribution structure 14. According to the invention, the data processing system also includes a clock control or power transitioning arrangement 15 interposed between the system clock generator 12 and clock distribution structure 14. Data processing system 10 also includes a fan 16 which is controlled by a fan controller 17. Fan 16 is positioned to force air over the surfaces of a heat sink 18 associated with processing device 11. Heat sink 18 is mounted in good thermal contact with the integrated circuit chip on which processing device 11 is implemented.

It will be appreciated that processor 11 is implemented on an integrated circuit chip which is mounted in a ceramic or other suitable package which is itself mounted on a print circuit board. The packaging elements and printed circuit board, as well as interconnections between the integrated circuit, package, and board are omitted from FIG. 1 so as not to obscure the invention in unnecessary detail.

Processing device 11 in FIG. 1 is illustrated as a single integrated circuit chip containing multiple processing elements 21, 22, and 23. In a preferred form of the invention, each of these processing elements may receive a separate clock signal from clock distribution structure 14. As will be discussed further below in connection with the operation of the invention, the various processing elements 21, 22, and 23 may receive different clock signal rates to effect a gradual transition between a high power dissipation level for the overall processing device 11 and a lower, low power dissipation level.

FIG. 1 indicates that processing elements 21, 22, and 23 are mounted on a single integrated circuit chip while system clock generator 12, clock distribution structure 14, and power transitioning arrangement 15 are all located off the integrated circuit chip. As indicated by dashed line 24, system clock generator 12, power transitioning arrangement 15, and clock distribution structure 14 may be integrated with the processing elements on a single integrated circuit chip. Even the logic portion of fan controller 17 may be implemented on the same integrated circuit chip. However, power circuitry for supplying power to fan 16 will commonly be located off-chip as indicated in FIG. 1.

The power transitioning arrangement 15 and fan controller 17 utilize two control signals in the embodiment of the invention shown in FIG. 1. Both types of signals may be generically referred to as power state signals. The signal applied at line 26 comprises a wake/sleep signal provided by a power management system associated with processing device 11. The signal applied at line 27 comprises a power on/off signal. The wake/sleep signal may be a binary signal with a high logical state representing one operational state or mode and a low logical state representing the other operational state or mode. This wake/sleep signal is generated through program code executed by a processor associated with processing system 10. In particular, the wake/sleep signal at line 26 may be generated from processing device 11 or, as indicated by dashed line 30, may be generated by some other processing device (not shown) associated with, or connected to, processing system 10. The power on/off signal applied via control line 27 is generated in connection with turning system 10 on and off and preferably also comprises a binary logic signal. For the purposes of the following claims, both the on and wake signal at the respective control line is associated with a high power dissipation state for processing device 11, while the off and sleep signals are each associated with a low power dissipation state for the processing device.

It will be appreciated that the two control signals shown in FIG. 1 are shown simply for purposes of describing the invention and are not intended to be the exclusive control signal arrangement for the invention. Although the power state signals are conveniently applied as simple binary state signals, more complicated signaling arrangements may be used within the scope of the invention as defined in the following claims.

Processing device 11 in FIG. 1 may reside at different power consumption or power dissipation states or levels. In particular, processing device 11 may operate at a high power dissipation level corresponding to a maximum system clock rate supplied to the various processing elements. Alternatively, processing device 11 may operate at one or more low power dissipation levels. The low power dissipation levels are each lower than the high power dissipation level and may be associated with a lower clock rate (or rates) supplied to one or more of the processing elements 21, 22, and 23. Also, an off condition in which the power is not supplied to the processor 11 may be considered a low power dissipation level with respect to any of the power dissipation levels in which power is supplied to the processing elements.

Fan 16 and heat sink 18 represent a cooling system for the processing device and particularly the integrated circuit chip on which processing device 11 is implemented. According to the invention, the cooling system, that is, fan 16 and heat sink 18 provide alternatively a low thermal impedance for processing device 11, and a relatively higher, high thermal impedance for the processing device. In particular, the high thermal impedance comprises the condition in which fan 16 is off or operating at a low speed. A low thermal impedance condition may be any condition in which fan 16 is operating at a higher speed to produce forced conductive cooling of heat sink 18.

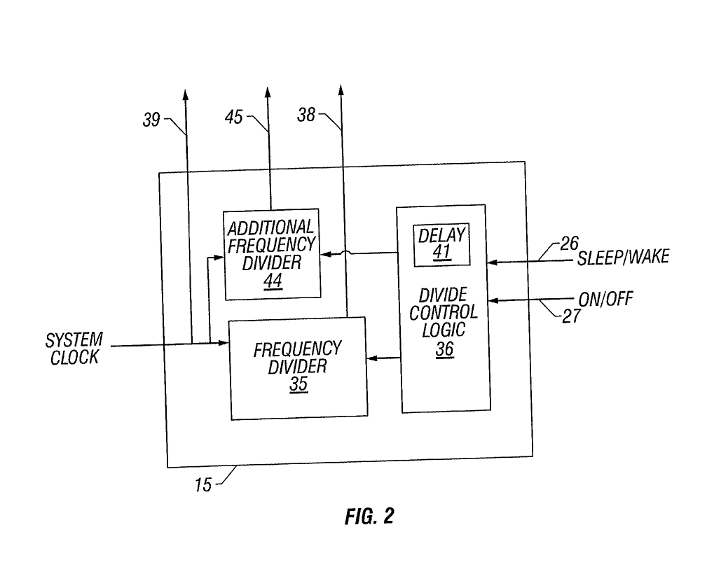

Referring now to FIG. 2, the preferred power transitioning arrangement 15 includes a clock control system having a frequency divider circuit 35 and a divider control circuit 36. This preferred power transitioning arrangement 15 receives the system clock signal from system clock generator 12 in FIG. 1, and both power state signals, the wake/sleep signal on line 26 and on/off signal on line 27, and provides a divider output at line 38. The illustrated form of the power transitioning arrangement 15 also includes a bypass 39 for sending the unmodified system clock signal to clock distribution structure 14 (FIG. 1). It will be noted that the bypass may alternatively be external to the clock control/power transitioning arrangement 15. That is, the system clock signal may be routed directly to clock distribution structure 14 over a suitable conductor rather than being routed through the clock control/power transitioning arrangement 15.

The clock control/power transitioning arrangement 15 functions to gradually change the clock rate applied to processing device 11 through clock distribution structure 14 shown in FIG. 1. By changing the clock rate, the clock control/power transitioning arrangement 15 changes the power dissipated in processing device 11 and thus changes the heat generated by the processing device. According to the invention, clock control/power transitioning arrangement 15 responds to a change from a wake to sleep signal by gradually reducing or transitioning from the normal operating or maximum system clock rate supplied to processing device 11 to a lower or sleep clock rate. In response to a change from the sleep to wake signal, clock control/power transitioning arrangement 15 transitions from the relatively low sleep clock rate to the maximum clock rate. Also, in response to change from an on to off power state signal, clock control/power transitioning arrangement 15 transitions down from the maximum clock rate to a rate at which the system power is cut off altogether. In response to an on power signal, clock control/power transitioning arrangement 15 gradually increases the clock rate to be applied to processing device 11 up to the maximum or normal operating clock rate.

Clock control/power transitioning arrangement 15 provides a modified clock signal by gradually incrementing or decrementing the division applied to the system clock signal through frequency divider circuit 35. Control for frequency divider 35 is provided by divider control circuit 36. In response to a change from on to off at line 27 or from wake to sleep at line 26, control circuit 36 preferably starts at a predetermined division and then increases the division incrementally after a delay at each particular level of division. In response to a change from off to on at line 27 or from sleep to wake at line 26, control circuit 36 preferably decreases the division applied by frequency divider 35, delaying for a period of time at each level of division, until reaching the maximum clock rate. The delay between incrementing or decrementing the frequency divider is chosen to provide a desired gradual cooling or heating of the processing elements. The delay for decrementing the division applied by divider 35 may or may not be equal to the delay for incrementing the division.

One preferred form of the invention also includes a delay element 41 in the divider control 36 for delaying the start of the clock rate change with respect to the time the power or operational state signal is received at line 26 or 27. This delay causes the clock transitioning to begin after a change in the state of the fan. That is, a power state signal at the fan controller causes the fan to immediately switch operational states either from off to on or from on to off. The preferred delay relative to the power state signal causes the clock rate transitioning to begin somewhat after the change in the operational state of the fan. This accounts for the fact that the fan takes a certain period of time to come up to operating speed or return to a full stop or low speed from the normal operating speed.

FIGS. 1 and 2 also illustrate an alternative or additional arrangement for transitioning the power dissipated in a multi-processing element processing device such as the one shown in FIG. 1. The power dissipated by processing device 11 in FIG. 1 may be transitioned between high and low levels by changing the clock rate to the different processing elements 21, 22, and 23 at different times. In one preferred form of the invention, clock control/power transitioning arrangement 15 includes a second or additional frequency divider circuit 44. This additional frequency divider circuit receives the system clock signal and operates under the control of controller 36 to provide an additional divider output at line 45. Thus, clock distribution structure 14 in this form of the invention receives the system clock signal at the maximum operating frequency and two different frequency divider outputs at lines 38 and 45. Clock distribution structure 14 may comprise a MUX (not shown) for selecting between the various clock signals and applying those clock signals to the various processing elements 21, 22, and 23. A MUX controller (not shown) associated with clock distribution structure 14 may use the same sleep/wake and on/off signals on lines 26 and 27 to control the MUX to provide the correct clock signals.

The multiple processing element power transitioning system reduces the clock rate to the processing elements 21, 22, or 23 in a step wise manner in response to a sleep or off signal. That is, in response to a sleep or off signal, controller 36 causes frequency divider 35 to produce a clock signal at a first division level. This first division level signal is first applied through clock distribution structure 14 to one of the processing elements, element 21 for example, while the other processing elements 22 and 23 continue to receive the regular system clock signal. After a certain delay, clock distribution structure 14 switches another processing element, processing element 22 for example, to receive the signal at the first frequency division level while processing element 23 continues to receive the regular clock signal and processing element 21 continues to receive the signal at the first frequency division level. After an additional delay, clock distribution structure 14 switches the final processing element 23 to receive the reduced clock rate at the first frequency division level. Once each processing element has been stepped down to the first frequency division level, controller 36 controls the additional frequency divider 44 to produce a signal at a still lower, second division level. As with the signal at the first frequency division level, clock distribution structure 14 distributes the signal at the second division level first to one processing element, then another, and another until all processing elements are stepped down to that clock frequency level. This gradual reduction in clock rates to the various processing elements continues until all processing elements are powered down to the desired level. This step wise process is reversed when transitioning from the low to high power operational state.

It will be appreciated that the rate at which instructions are issued in the processing device 11 may also be used to transition the processing device between high and low power levels. The instruction issuance rate may be varied either alone or in concert with the above-described techniques to effect a power level transitioning within the scope of the following claims.

The preferred form of the invention shown in FIG. 1 also includes a way to bypass the power transitioning arrangement 15 as needed. This power transitioning bypass arrangement bypasses power transitioning arrangement 15 in predefined on or sleep transitions and results in a less favorable, faster heating in processing device 11 and associated structures. However, the bypass may be necessary or desirable in certain circumstances such as when a user desires that the system reach its normal operating state quickly. The bypass may be controlled by functionality included in the power management system that detects a user either at the processing system 10 or accessing the processing system over a network. The presence of the user may be determined by the presence of user inputs at a keyboard or other user input device associated with the system or by the reception of a packet of data over a network through which the system is accessible. The bypass may be accomplished with a separate bypass control signal applied to clock distribution structure 14 shown in FIG. 1 as indicated at dashed line 48. This bypass signal may cause the clock distribution structure to apply the full system clock rate to processing device 11 regardless of the power state signals applied through lines 26 and 27 to power transitioning arrangement 15.

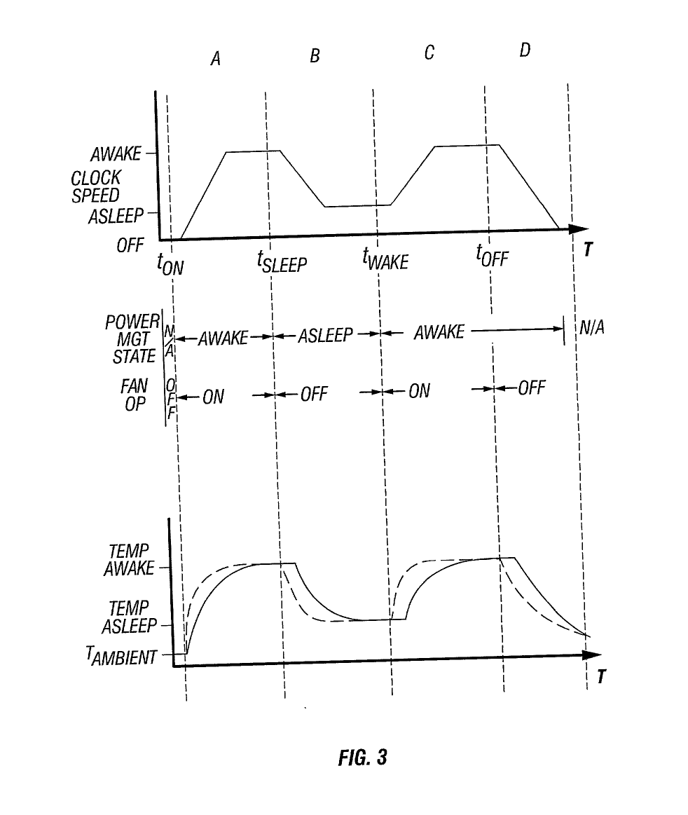

FIG. 3 illustrates four different operating state changes for processing system 10 according to the present invention. The first state change is shown in area A of the related plots and shows the transitioning from an off condition to the high power or normal operating state for processing system 10. Area B of FIG. 3 shows the transition from the high power operating state to a low power or sleep mode. Area C shows the transition from the sleep mode back to the high power mode. Finally, area D of the figure shows the transition from the high power operating state to an off condition according to the invention. In the temperature plot at the lower portion of FIG. 3, the solid line represents the temperature change produced according to the invention while the dashed line represents the temperature change without providing power transitioning according to the invention.

Referring to area A of FIG. 3 and to the schematic diagram of FIG. 1, system 10 receives a power on signal shown at time tₒₙ. In response to the power on signal, which may be applied through control line 27 in FIG. 1, fan 16 is immediately switched on through fan control 17 to provide a low thermal impedance at heat sink 18. After the preferred delay provided by delay element 41 in FIG. 2 to allow fan 16 to come up to operating speed, the clock rate directed to processing device 11 through clock distribution structure 14 is gradually increased up to the normal operating clock speed which corresponds to the maximum power dissipation in the processing device. It will be noted referring to the temperature plot of FIG. 3 that the power transitioning results in a less abrupt temperature change in processing device 11.

Referring to area B of FIG. 3 and the schematic of FIG. 1, a sleep signal applied at time tₛₗₑₑₚ on line 26 in the schematic immediately switches fan 16 to an off condition through control 17, allowing the fan blades to slow to a stop. After the preferred delay, power transitioning arrangement 15 according to the invention gradually decreases or transitions the clock rate from the maximum clock rate to a sleep clock rate. Once again referring to the temperature plot at the lower part of FIG. 3, the power transitioning results in a less abrupt temperature decrease in processing device 11 occasioned by the cycling from the awake to sleep mode according to the power management system.

Referring to area C along the time line of FIG. 3, a state change from the sleep state to an awake state at time t_{wake} causes fan 16 shown in FIG. 1 to immediately switch to the on condition. After the preferred delay (provided by delay element 41 in FIG. 2) corresponding generally to the time required for fan 16 to come up to proper operating speed, clock control/power transitioning arrangement 15 gradually increases the clock rate to be provided to processing device 11 from the relatively low sleep rate up to the maximum system clock rate. Again this power transitioning or gradual increase reduces the rate of temperature change from the sleep operating temperature to the awake operating temperature.

Referring now to area D along the time line of FIG. 3, a power off signal applied at time t_{off} through control line 27 in the schematic of FIG. 1 causes fan 16 to be immediately switched to the off state through fan control 17. After a delay (again provided by delay element 41 in FIG. 2) to account for the delay between the time fan 16 is turned off and the blades actually stop, clock control/power transitioning arrangement 15 begins to gradually decrease the clock rate to a relatively low clock rate at which point the system power may be cut off. As in the other instances, gradually transitioning a power dissipation in processing device 11 makes the temperature change in the processing device more gradual and thereby helps reduce thermal stress and fatigue occasioned by the temperature change.

The above description of FIG. 3 refers solely to the power transitioning provided by the clock control system shown in FIG. 2. It will be appreciated that power transitioning in a multi-element processing device such as that shown in FIG. 1 may be accomplished through powering down or powering up the individual processing elements separately at different times. This multi-element processing device power transitioning may be done in addition to the gradual clock modification described above.

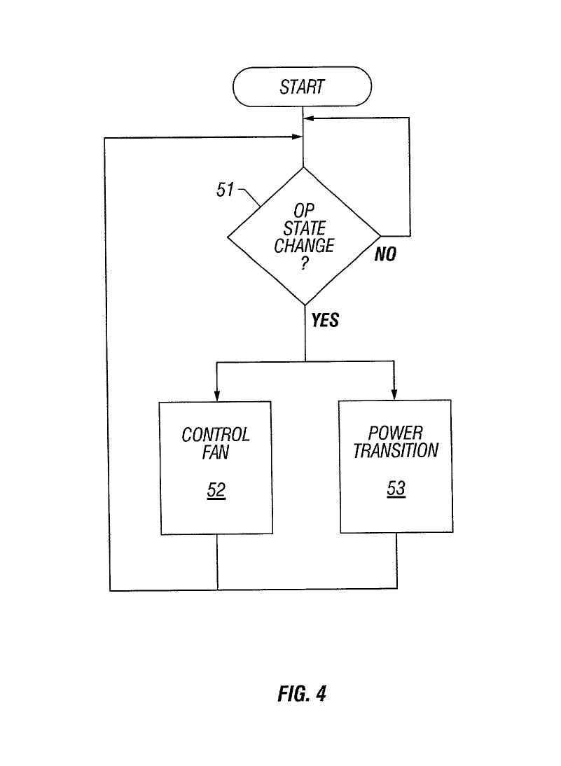

The operation of the invention is also illustrated in the flow chart shown in FIG. 4. In this flow chart the start condition may be any operational state for the processing device 11 shown in FIG. 1. At decision block 51, the change of operational state is detected by processing system 10 in FIG. 1. This change in operational state may be signaled by a signal or signal change at the sleep/wake control line 26 or a signal change at the on/off control line 27.

If a power or operational state change is detected, the method includes switching fan 16 in FIG. 1 to the appropriate condition as shown at process block 52 in FIG. 4. Where the power state is changing from low to high, fan 16 is switched to the on condition. Where the power state for processing device 11 is changing from a low power state to a high power state, fan 16 is switched to the off condition. The switching is performed through fan control 17 in either case.

As shown at process block 53 in FIG. 4, the power transitioning arrangement (15 in FIG. 1) responds to the change in power/operational state for processing device 11, by starting the appropriate transition in power dissipation in the processing device. Preferably this transitioning begins only after a predetermined delay with respect to the switching of fan 16. This power transitioning step may be accomplished in any case by modifying the clock rate applied to processing device 11 as discussed above, by changing the clock rate to the various processing elements 21, 22, and 23 at different times, and/or by changing the rate at which instructions are issued in the processing elements.

The above described preferred embodiments are intended to illustrate the principles of the invention, but not to limit the scope of the invention. Various other embodiments and modifications to these preferred embodiments may be made by those skilled in the art without departing from the scope of the following claims.

1. An apparatus for reducing the rate of temperature change in a processing device due to a change in operational state for the processing device, the apparatus including:
(a) a power transitioning arrangement for transitioning power dissipation in the processing device between a low power dissipation level and a high power dissipation level in response to a change in a power state signal, the high power dissipation level being relatively greater than the low power dissipation level;
(b) a cooling system alternatively providing a low thermal impedance for the processing device and a relatively higher, high thermal impedance for the processing device; and
(c) a cooling system controller for placing the cooling system at the high thermal impedance in conjunction with a transitioning from the high power dissipation level to the low power dissipation level, and for placing the cooling system at the low thermal impedance in conjunction with a transitioning from the low power dissipation level to the high power dissipation level.

2. The apparatus of claim 1 wherein the power transitioning arrangement includes a delay element for delaying the transitioning between power dissipation levels relative to a change between the low thermal impedance and the high thermal impedance.

3. The apparatus of claim 1 wherein the power transitioning arrangement includes:
(a) a frequency divider connected to receive a system clock for the processing device and providing a frequency divider output; and
(b) a frequency controller operatively connected to the frequency divider for controlling the frequency division function applied to the system clock by the frequency divider.

4. The apparatus of claim 3 wherein the power transitioning arrangement further includes a frequency divider bypass and a system clock output.

5. The apparatus of claim 3 further including:
(a) an additional frequency divider connected to receive the system clock signal and providing an additional frequency divider output, the additional frequency divider being operatively connected to the frequency controller; and
(b) a multiple clock distribution system associated with the processing device for distributing both the frequency divider output and the additional frequency divider output to the processing device.

6. The apparatus of claim 1 wherein the power state signal comprises a wake/sleep signal and the high power dissipation level corresponds to a maximum clock rate for the processing device while the low power dissipation level corresponds to a sleep clock rate for the processing device.

7. The apparatus of claim 1 wherein the cooling system comprises a heat sink and a fan positioned to affect airflow over the heat sink.

8. The apparatus of claim 7 wherein the cooling system further includes a cooling system switching device connected to receive the awake/asleep signal for the processing device and a power on/off signal for a processing system including the processing device.

9. The apparatus of claim 1 further including a power transitioning bypass arrangement for causing the processing device to operate at the high power dissipation level substantially immediately upon receipt of a power transitioning bypass signal.

10. A processing system having at least one processing element adapted to operate using a clock input, and also having a system power management arrangement providing alternatively a high power state signal and a low power state signal, the processing system including:
(a) a system clock arrangement providing the clock input to the processing system, the system clock arrangement for transitioning from a high clock rate at the clock input to a relatively slower, low clock rate at the clock input in response to a change from the high power state signal to the low power state signal, the system clock arrangement also for transitioning from the low clock rate at the clock input to the high clock rate in response to a change from the low power state signal to the high power state signal;
(b) a cooling system providing alternate thermal impedance states for transferring heat from the processing system, the thermal impedance states including a high thermal impedance state and a relatively lower, low thermal impedance state; and
(c) a cooling system controller operably connected to the cooling system for changing the thermal impedance state of the cooling system from the high thermal impedance state to the low thermal impedance state in response to a change from the low power state signal to the high power state signal, and for changing the thermal impedance state of the cooling system from the low thermal impedance state to the high thermal impedance state in response to a change from the high power state signal to the low power state signal.

11. The apparatus of claim 10 wherein the power transitioning arrangement includes a delay element for delaying the transitioning between power dissipation levels relative to a change between the low thermal impedance and the high thermal impedance.

12. The apparatus of claim 10 wherein the power transitioning arrangement includes:
(a) a frequency divider connected to receive a system clock for the processing device and providing a frequency divider output; and
(b) a frequency controller operatively connected to the frequency divider for controlling the frequency division function applied to the system clock by the frequency divider.

13. The apparatus of claim 12 wherein:
(a) the processing system includes a second processing element and the system clock arrangement further includes an additional frequency divider connected to receive the system clock and providing an additional divider output; and
(b) the processing system further includes a multiple clock distribution system for distributing both the frequency divider output and the additional frequency divider output to the processing system.

14. The apparatus of claim 10 wherein the cooling system comprises a heat sink and a fan positioned to affect airflow over the heat sink.

15. The apparatus of claim 14 wherein the cooling system further includes a cooling system switching device connected to receive the wake/asleep signal for the processing device and a power on/off signal for a processing system including the processing device.

16. The apparatus of claim 10 further including a power transitioning bypass arrangement for causing the processing device to operate at the high power dissipation level substantially immediately upon receipt of a power transitioning bypass signal.

17. A method for reducing the rate of temperature change in a processing device as the processing device undergoes a change in operational state, the method including the steps of:
(a) transitioning power dissipation in the processing device between a low power dissipation level and a high power dissipation level in response to a change in a power state signal, the high power dissipation level being relatively greater than the low power dissipation level; and
(b) placing a cooling system for the processing device at a high thermal impedance in conjunction with a transitioning from the high power dissipation level to the low power dissipation level, and placing the cooling system at the low thermal impedance in conjunction with a transitioning from the low power dissipation level to the high power dissipation level.

18. The method of claim 17 further including the step of delaying the transitioning between power dissipation levels relative to a change between the low thermal impedance and the high thermal impedance.

19. The method of claim 17 wherein the step of transitioning power dissipation includes gradually modifying the clock rate of the processing device.

20. The method of claim 20 wherein the step of transitioning power dissipation includes modifying the power dissipation of different processing elements in the processing device at different times.
